(19) United States
(12) Patent Application Publication
(10) Pub. No.: US 2026/0026486 A1
(43) Pub. Date: Jan. 29, 2026

(54) Downrigger Trolling Apparatus

(71) Applicants: Richard Lehman, Palm Coast, FL (US); Richard Underwood, Palm Coast, FL (US)

(72) Inventors: Richard Lehman, Palm Coast, FL (US); Richard Underwood, Palm Coast, FL (US)

(21) Appl. No.: 19/281,582

(22) Filed: Jul. 26, 2025

Related U.S. Application Data
(60) Provisional application No. 63/676,522, filed on Jul. 29, 2024.

(51) Int. Cl. A01K 91/08

(52) U.S. Cl. CPC A01K 91/08

(57) ABSTRACT

An underwater fishing lure reciprocating device for downrigger trolling apparatus comprises a mounting member that is attached to the end of the downrigger cable and a reciprocating member movably mounted on the mounting member. The reciprocating member includes a clip for holding the fishing line which reciprocates with movement of the reciprocating member with respect to the mounting member. The reciprocating member to reciprocate a draw line that is connected to the fishing line when the device is being towed behind a boat. Desirably, the reciprocating member engages and releases the draw line when it is towed behind a boat. The engagement and release of the draw line causes the lure on the fishing line to travel at varied speeds behind the reciprocating device.

### PRIORITY

The present application is a continuation in part of U.S. Ser. No. 63/676,522 filed on Jul. 29, 2024.

### BACKGROUND OF THE INVENTION

### 1. Field of the Invention

The present invention relates to downrigger trolling apparatus and more particularly to an underwater fishing lure reciprocal trolling device for use in connection with downrigger trolling apparatus.

### 2. Description of the Prior Art

A downrigger is employed in the sport of fishing for trolling below the surface of the water. A downrigger includes a cable mounted on a large reel on the boat. Sometimes a depth measuring device is incorporated in the apparatus. A heavy weight is attached to the end of the downrigger cable and a fishing line with attached lure is releasably clipped to the weight or along the length of the cable. The weight is lowered to the desired depth with the fishing line attached thereto. When a fish bites the lure, the line becomes unclipped from the weight and the fisherman is able to play and reel in the fish without having to overcome the drag caused by the heavy weight attached to the downrigger cable.

In a trolling operation, particularly when a downrigger is employed for trolling, the fishing lure is pulled through the water at a relatively constant rate of speed. In a casting operation, on the other hand, the fisherman is able to physically impart a pulsating or jerking movement to the lure as they reel in the fishing line by periodically pulling up on the tip of the rod. This jerking movement provides a greater attraction for fish than a steady movement of the lure. The absence of a jerking or pulsating movement in the lure employed in trolling is one of the drawbacks with this type of operation because the lure travels at a straight and constant rate of speed. Experienced fisherman may also perform S-turns during trolling. This has the advantage of varying the speed of the lures depending on the side of the boat. The lure on the side of the boat along the outside of S-turn will travel faster than the lure on the inside of the S-turn. Therefore, the lure on the inside of the S-turn will flutter in the water due to the decreased or stopped forward movement. This is particularly attractive to fish because it imitates an injured bait. Despite the effectiveness of this maneuver, it is not practical in smaller bodies of water or in areas of boat traffic or underwater obstacles.

U.S. Pat. No. 4,204,356 granted to Smith, discloses an approach to providing a variable lure speed while trolling. As labelled as prior art in FIG. 1 of this disclosure, the Smith reference discloses a waterwheel shaped member having baffles to rotate waterwheel shaped member as the device is pulled through the water during the trolling process. One end of a rigid trailing arm is connected eccentrically to the water wheel shaped member. The other end of the trailing arm is connected to the fishing lure. As the waterwheel rotates, the trailing arm moves forward and backward relative to the travel of the boat to impart a similar motion to the fishing lure. Of the many deficiencies or limitations of this invention is that the imparted motion to the fishing lure is limited by the distance of travel of the trailing arm. For example, if the diameter of the waterwheel is twelve inches, the imparted motion to the fishing lure may be about eight inches. This variation of the speed and travel of this fishing lure may not be sufficient to impart a fluttering motion to the lure or a variation that is perceptible to the fish during trolling.

U.S. Pat. No. 4,509,287 granted to Hood discloses another approach to providing a variable lure speed while trolling or attached to a buoy device in the current of a river. As labelled as prior art in FIGS. 2 and 3 of this disclosure, the Hood reference discloses a frame member that is connected directly to the fishing lure. The frame member includes a spool that alternately winds or releases line for the fishing lure and therefore moves the fishing lure forward or backward relative to the frame. The frame also includes a propeller mounted on the forward end of the frame with a bevel gear that engages and rotates the spool. A lever is also provided to release the spool when the line is wound on the spool. One of the deficiencies of this disclosure is that the entire assembly must be retrieved onto the boat to determine if fish have been hooked on the fishing lure.

One of the principal objects of the present invention is to provide a reciprocal trolling device that can be used in trolling and particularly in connection with downrigger trolling that superimposes a jerking or reciprocating movement of the fishing lure on top of the steady movement of the lure as it is pulled through the water.

One of the other objects of the present invention is to provide a device wherein the distance between the fishing lure and reciprocal trolling device may be adjusted to accommodate trolling speed and desired types of fish.

One of the other objects of the present invention is to provide a device wherein a keel member may be adjusted to cause the reciprocal trolling device to track away from the boat to allow multiple reciprocal trolling devices to be used on the boat and decrease the likelihood of entanglement.

One of the other objects of the present invention is to provide a variable distance draw line that varies the lateral movement of the lure relative to the device and then is released from the fishing line when a fish bites the lure to allow the fisherman to fight the fish without interference from the downrigger assembly

### SUMMARY OF THE INVENTION

The present invention comprises an underwater fishing lure reciprocal trolling device for a downrigger trolling apparatus, wherein a fishing line and attached lure are releasably clipped to a towing line or weighted cable. The reciprocal trolling device is lowered from a boat by a reel to a predetermined depth into the water for trolling. The reciprocal trolling device comprises a frame member attached to the cable and generally consists of a vertical frame member and a horizontal frame member. A reciprocating member is movably mounted on the vertical portion of the frame member and the horizontal portion of the frame member includes a line engaging member for engaging and releasing the fishing line. The reciprocating member is movable with respect to the frame member such that the line engaging means is caused to engage a line capture device which then causes the line to wrap around a wrapping cylinder. As the line is wrapped around the cylinder, the fishing lure is moved forwardly relative to the frame member. When the line reaches a desired distance relative to the frame member, the line is released from the line capture device and the fishing lure is allowed to flutter and move away from the frame member. Once the line is released from the wrapping cylinder, the process begins again with the capture of the line by the line capture device.

As described in more detail below, the frame member includes a conventional downrigger weight or cannonball that is connected to the bottom of the vertical portion of the frame member by a conventional snap swivel. This allows the user to adjust the amount of weight used depending on the trolling speed, currents and other environmental conditions. A conventional connection eye is also provided at the corner or intersection of the vertical and horizontal portions of the frame member. The connection eye allows the user to connect the frame member to the cable from the downrigger apparatus.

A keel member is also located on the vertical portion of the frame member. The keel member is adjustable relative to the vertical portion of the frame member to control the desired movement of the frame member in the water during trolling. For example, the keel member may be adjusted to cause the frame member to move away from the boat so that multiple frame members may be used on a single boat. The keel member may also be adjusted to cause a straight line of travel or an inward direction of travel relative to the boat.

The vertical portion of the frame member also includes the reciprocating member consisting of adjustable fin members, a line engagement connector or rod and the wrapping cylinder. The reciprocating member is preferably located approximately midway along the lengthwise dimension of the vertical portion of the frame member. The reciprocating member rotates in response to the movement of the frame member through the water. The water movement causes the fin members and line engagement connector to rotate along a fixed rod that is horizontally oriented relative to the frame member. Additionally, the fin members and line engagement connector are oriented to rotate around the wrapping cylinder in response to movement in the water. The line engagement connector includes one end of the draw line releasably attached thereto and rotation of the line engagement connector pulls the draw line to wrap around the wrapping cylinder.

The horizontal portion of the frame member includes the line capture device extending downwardly from an approximate midpoint for the horizontal portion. The line capture device includes a plurality of engagement wings to capture the draw line in response to the rotation the line engagement connector. When the draw line from the line engagement connector engages the engagement wings of the capture device, the draw line is pulled through the engagement wings and is wrapped along the wrapping cylinder. The draw line also includes at least one adjustable bead member along the length thereof. As the draw line is drawn through the engagement wings of the line capture device, the adjustable bead is drawn toward the engagement wings. When the bead reaches the engagement wings, the draw line is released. This contact causes the draw line to release and unwrap from the wrapping cylinder to cause the distance of the fishing lure relative to the frame member to increase. As the draw line is released, the slack in the draw line causes the lure to flutter or alter the line of travel temporarily. The user is able to adjust the length of the draw line that is wrapped around the wrapping cylinder to accommodate the speed of trolling, the type of target fish and other conditions. As the line engagement connector rotates, the draw line is again captured by the line capture device and the distance between the fishing lure and the frame member decreases. Finally, a draw line guide is located on the horizontal portion of the frame member. This draw line guide may be a variety of shapes and is designed to allow the draw line to pass therethrough. The draw line extends from the draw line guide to a line stabilizer that preferably consists of a rod shaped member with a weight extending downwardly therefrom. The line stabilizer provides stability to the draw line and minimizes the rotation or twisting of the draw line and fishing lure in response to the engagement and release of the draw line.

Finally, a conventional quick release connection is provided between the draw line and fishing line to allow the fishing lure and fishing line to be released from the frame member when a fish bites the lure.

These and other advantages and features of the present invention will hereinafter appear. For purposes of illustration, but not of limitation, a preferred embodiment of the present invention is described in detail below and shown in the appended drawings.

### BRIEF DESCRIPTION OF THE DRAWINGS

FIG. 1 is a perspective view showing the prior art apparatus of U.S. Pat. No. 4,204,356 granted to Smith employed in a downrigger trolling operation.

FIG. 2 is a diagrammatic view showing the prior art apparatus of U.S. Pat. No. 4,509,287 granted to Hood in a trolling configuration;

FIG. 3 is perspective view of the prior art apparatus U.S. Pat. No. 4,509,287 granted to Hood;

FIG. 4 is a diagrammatic view of the preferred configuration of the present invention employed in a downrigger trolling configuration;

FIG. 5 is a side perspective view of the frame member of the present invention;

FIG. 6 is a top perspective view of the frame member of the present invention;

FIG. 7 is a rear end view of the frame member of the present invention;

FIG. 8 is an enlarged view of the draw line engaged with the fin, line engagement connector, line capture device and wrapping cylinder; and

FIG. 9 is an enlarged view of an end of the draw line engaged with the line stabilizer, quick release and fishing line.

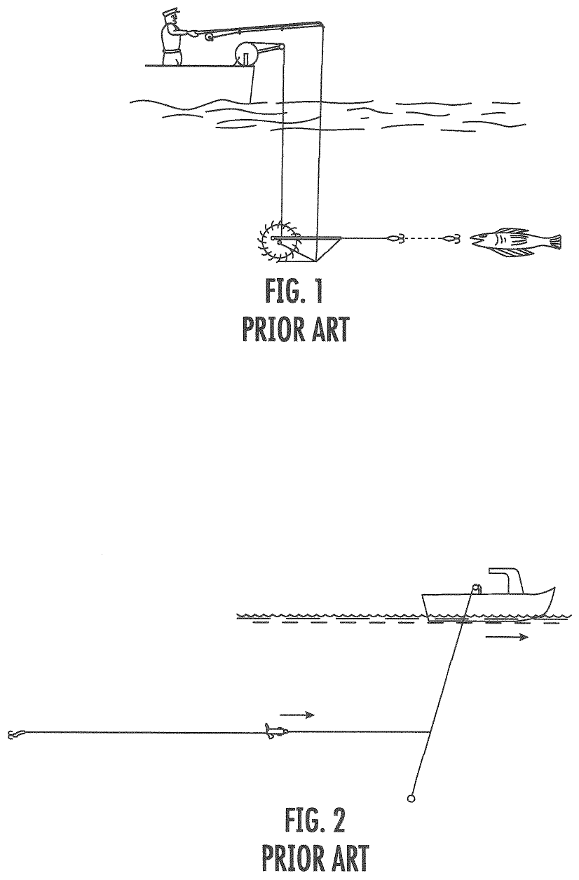

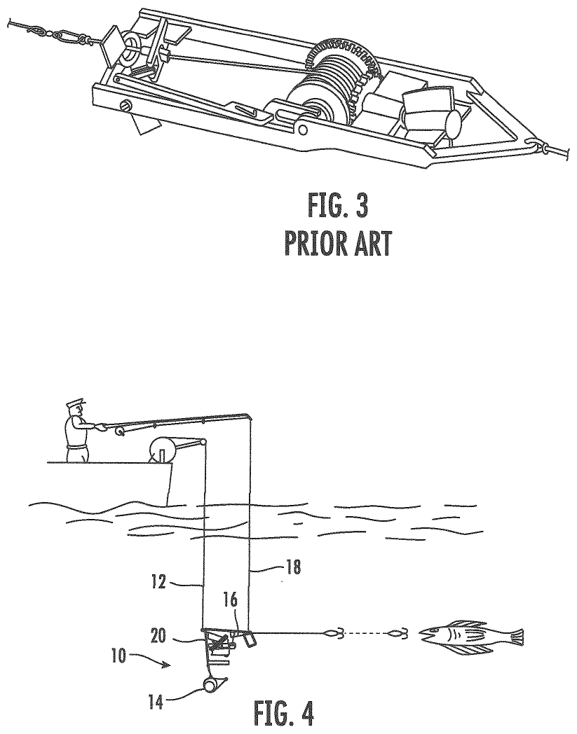

### DETAILED DESCRIPTION OF THE PREFERRED EMBODIMENTS

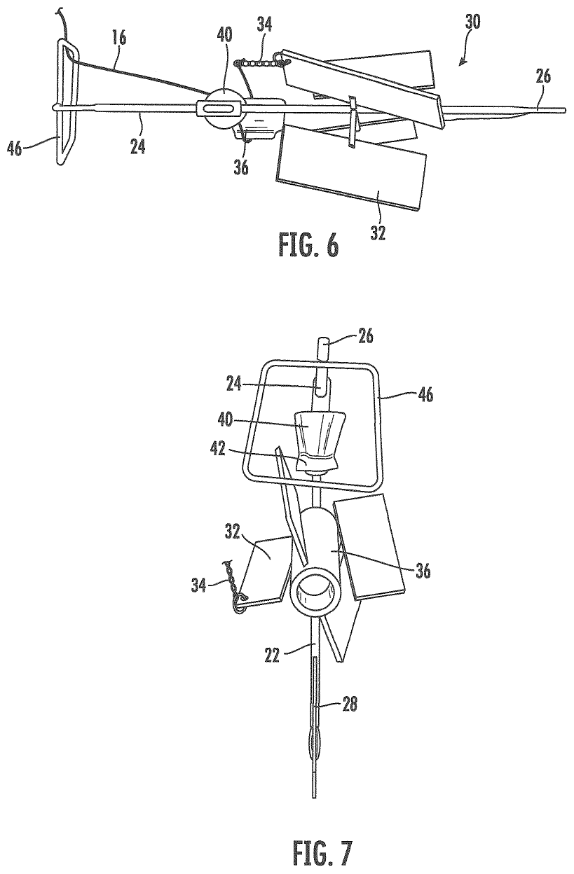

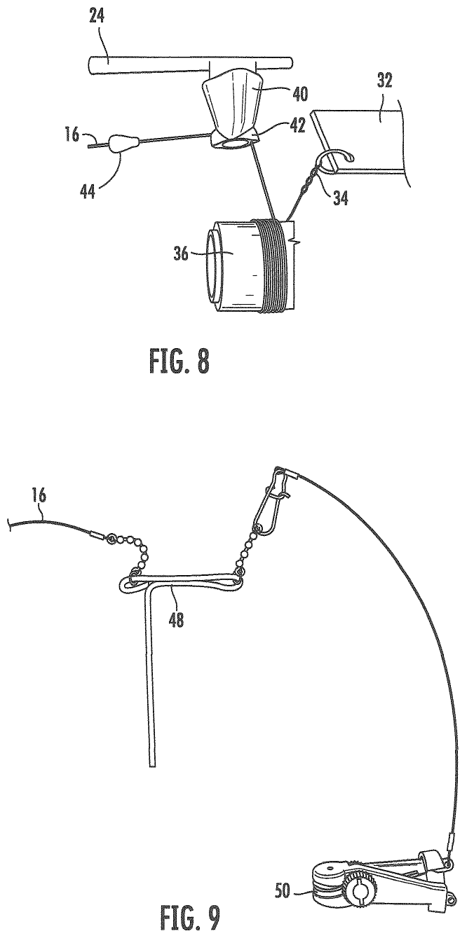

Referring now to the drawings and more particularly to FIGS. 4-9 of the present invention wherein a reciprocal trolling device 10 is constructed in accordance with the present invention and is shown attached to the end of a downrigger cable 12 for use in a downrigger trolling operation. In this operation, a conventional downrigger weight 14 is releasably attached to the reciprocal trolling device 10. As shown diagrammatically in FIG. 4 conventional downrigger system includes a reel and a short rod that is mounted on the rear transom of a boat. The downrigger cable 12 is lowered to a predetermined depth in the water, with a fishing line 18 being clipped to the draw line 16 of the reciprocal trolling device 10 in order to retain a lure 52 at the predetermined depth in the water. The fishing line is attached to a conventional fishing rod 28, which is operated by a fisherman 30.

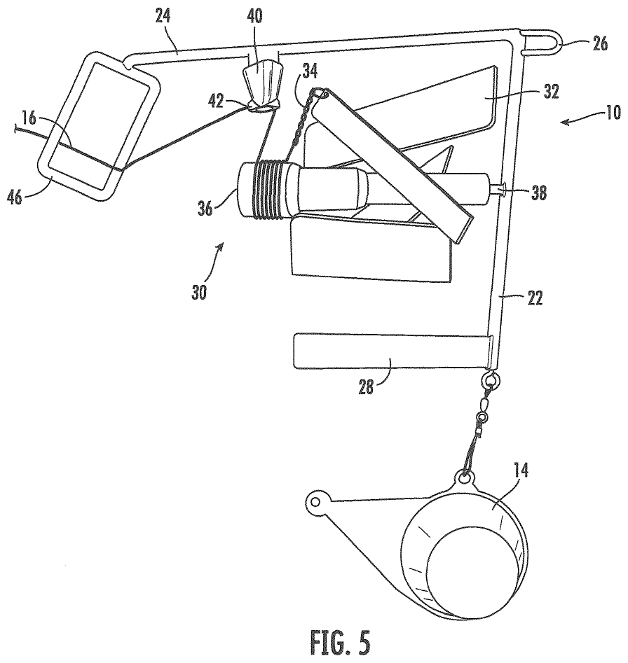

As shown in more detail in FIG. 5, the reciprocal trolling device 10 comprises a frame member 20, which is attached to downrigger cable 12 at a connection eye 26 on an upper forward end of the frame member 20. The frame member 20 preferably includes a vertical frame member 22; a horizontal frame member 24; a reciprocating member 30; and a line capture device 40. The preferred form of the frame member 20 is constructed of a metal such as stainless steel to provide durability and weight to allow the reciprocal trolling device to track along the desired line beneath the boat. The remaining components are preferably constructed of durable plastic material to allow for repeated movement relative to the frame member 30 and to avoid deterioration in fresh or saltwater conditions. In a further preferred form of the present invention, one or more of the reciprocating member 30, fin members 32 and line capture device 40 may be constructed using 3D printing. In use, the frame member 20 is aligned in a first plane and the vertical frame member 22 is oriented generally vertically in use and extends downwardly from the connection eye 26. The vertical frame member 22 of the frame member 20 includes the downrigger weight releasably attached to the bottom end of the vertical frame member 22. As shown, a keel member 28 is provided above the connection vertical frame member 22 to the down rigger weight 14 and consists of a generally rectangular member that is bendable and movable relative to the vertical frame member 22. The keel member 28 is adjustable to cause the reciprocal trolling device 10 to track in the water in a desired path or angle relative to the boat by deflecting the flow of water as the reciprocal trolling device 10 is moved through the water. For example, keel member 28 may be adjusted relative to the first plane to cause the reciprocal trolling device to track away from the boat to allow for the use of multiple reciprocal trolling devices on a boat. The keel member 28 may also be adjusted for inward travel towards the boat or straight travel by being aligned with the first plane.

A reciprocating member 30 is located above the keel member 28 on the vertical frame member 22. The reciprocating member is oriented generally parallel to the first plane of the frame member 20 and is preferably positioned about halfway along the lengthwise dimension of the vertical frame member 22 on the frame member 20. The reciprocating member 30 includes a fixed rod 38 which is aligned with the first plane of the frame member 20 and extends rearwardly from the forward portion of the frame member 20 and vertical frame member 22. Adjustable fin 32 members are located along the fixed rod 38 and are oriented to extend outwardly and generally in a nonplanar orientation to the first plane of the frame member 20. The fin members 32 spin around the fixed rod 38 in response to the motion of the water. The angle of the fin members 32 may be adjusted relative to the planar orientation of the frame member 20 to increase or decrease the speed of rotation around the fixed rod 38. A line engagement connector 34 also extends from the fixed rod 38 and rotates relative to the motion of the water and fin members 32. The line engagement connector 34 may be a separate rod shaped member or a releasable connector attached to one of a fin member 32 and the end of the draw line 16. The rearward portion of the reciprocating member 30 includes a wrapping cylinder 36 fixedly attached to the rear end of the fixed rod 38.

The horizontal frame member 24 of the frame member 20 includes a line capture device 40 extending downwardly from the horizontal frame member 24. The line capture device 40 is generally aligned with the first plane of the frame member 20. The line capture device 40 is a generally cylindrical member that is in a fixed position relative to the horizontal frame member and includes a plurality of engagement wings 42 having a plurality of grooves therein to receive the draw line 16 during the operation of the reciprocal trolling device 10. The end of the horizontal frame member 24 includes a draw line guide 46 extending downwardly from the horizontal frame member 24 to allow the draw line 16 to travel therethrough and align the draw line with the line capture device 40 and minimize twisting and turning of the draw line 16 as it is captured and released as described below.

As shown in FIG. 5, the frame member includes the draw line 16 extending from the line engagement connector 34, around the wrapping cylinder 36, in engagement with the engagement wings 42 on the capture device 40 and though the draw line guide 46. The other end of the draw line 16 also includes a line stabilizer 48 to limit rotational movement of the draw line 16. As shown in FIG. 9, the other end of the draw line 16 includes the line stabilizer 48 as well as an optional flexible shock absorbing section (not shown) connected to a conventional quick release mechanism 50. The quick release mechanism 50 releasably attaches the draw line 16 to the fishing line 18 and lure 52. The quick release mechanism functions similar to a clothes pin such that when a fish bites, the fishing line is released from the quick release 50 and the fisherman is allowed to fight the fish without the additional drag and weight of the reciprocal trolling device.

As the reciprocal trolling device 10 is drawn through the water, the fin members 32 and line engagement connector 34 are misaligned to the planar alignment of the frame member 20 and are oriented to rotate about the fixed rod 38. The line engagement connector 34 includes one end of the draw line 16 attached thereto. As the line engagement connector 34 rotates, the draw line 16 is pulled through the draw line guide 46 and into engagement with the line capture device 40. The draw line 16 is pulled into contact with and through the engagement wings 42 of the line capture device 40. The rotation of the line engagement connector 34 causes the draw line 16 to be wrapped around the wrapping cylinder 36 of the reciprocating member 30. The draw line 16 continues to be pulled through the engagement wings 42 of the line capture device 40 until an adjustable bead 44 on the draw line 16 is pulled into contact with the engagement wings 42. Contact between the adjustment bead and the engagement wings of the line capture device 40 causes the draw line 16 to release from the engagement wings 42. The tension on the draw line 16 is then released and the draw line 16 that was previously wound around the wrapping cylinder 36 is allowed to release freely. This release of the draw line 16 tension causes the release of the tension on the fishing line and causes the lure 52 to flutter or change the speed of travel in the water as it moves away from the reciprocal trolling device 10. When tension returns to the draw line 16, the process begins again wherein the draw line 16 engages the engagement wings 42 of the line capture device 40 and is wrapped around the wrapping cylinder 36 by the rotation of the line engagement connector 34. The adjustable bead 44 is adjustable along the length of the draw line 16 to allow the user to change the amount of draw line 16 that is wrapped around the wrapping cylinder 36 to increase or decrease the amount of draw line wrapped along the wrapping cylinder and increase or decrease the amount of movement of the fishing line and lure relative to the reciprocal trolling device 10.

It is contemplated that all of the foregoing components may be fabricated at least partially from metal and/or plastics and would possess sufficient weight so that the weight of the reciprocal trolling device 10 will be stable as it travels through the water and the separate downrigger weight 14 will allow the assembly to travel smoothly though the water at the desired depth and speed.

It should be understood that the foregoing embodiments of the present invention are merely illustrative of the preferred practice of the present invention and that various modifications and changes in the arrangements and details of construction of the embodiments shown herein may be made without departing from the spirit and scope of the present invention.

I claim:

1. An underwater reciprocating trolling device for downrigger trolling wherein a fishing line and attached lure are releasably clipped to a weighted cable and lowered from a boat by a reel to a desired depth into the water for trolling, said reciprocating trolling device being non-floating and being adapted to be lowered to said desired depth on a cable, the reciprocating trolling device comprising:
a mounting frame attached to the cable and having a vertical frame member and horizontal frame member;
a draw line extending between the mounting frame and the fishing line;
a reciprocating member movably mounted on the vertical frame member, the reciprocating member including line engaging member for engaging the draw line, the reciprocating member being movable with respect to the mounting frame such that the line engaging member is caused to reciprocate forward and backward with respect to the mounting frame generally in the direction of movement of the mounting frame as the reciprocating device is towed through the water, said reciprocation of the line engaging member imparting forward and backward movement to the draw line and fishing line as the reciprocating trolling device is towed through the water.

2. The underwater reciprocating trolling device according to claim 1 wherein the reciprocating member includes a plurality of fin members and a line engagement member that are operated by the movement of the water over the reciprocating device causing winding and unwinding of the draw line on a wrapping cylinder.

3. The underwater reciprocating trolling device according to claim 1 wherein the vertical frame member and horizontal frame member are aligned in a first planar orientation and at least a portion of the reciprocating member is not aligned with the first planar orientation of the vertical frame member and horizontal frame member.

4. The underwater reciprocating trolling device of claim 3 wherein a plurality of fin members are located on the reciprocating member and said fin members are not aligned with the first planar orientation of the vertical frame member and horizontal frame member.

5. The underwater reciprocating trolling device of claim 1 wherein the reciprocating member includes a plurality of fin members and a line engagement member that rotate relative to the mounting frame.

6. The underwater reciprocating trolling device of claim 5 further including a generally cylindrical line capture device extending from the horizontal frame member to releasably engage the draw line.

7. The underwater reciprocating trolling device of claim 6 further including a draw line guide extending from the horizontal frame member to align the draw line with the line capture device.

8. The underwater reciprocating trolling device of claim 6 wherein the draw line includes a bead thereon to cause the draw line to release from engagement with the line capture device.

9. The underwater reciprocating trolling device of claim 1 wherein the reciprocating member includes a wrapping cylinder, fin members and a line engagement member and movement of the fin members and line engagement member relative to the wrapping cylinder causes winding and unwinding of the draw line on the wrapping cylinder.

10. An underwater reciprocating trolling device for downrigger trolling wherein a fishing line and attached lure are releasably clipped to a weighted cable and lowered from a boat by a reel to a desired depth into the water for trolling, said reciprocating trolling device being non-floating and being adapted to be lowered to said desired depth on a cable, the reciprocating trolling device comprising:
a mounting frame attached to the cable and having a vertical frame member and horizontal frame member wherein the vertical frame member and horizontal frame member form a first generally planar orientation;
a draw line extending between the mounting frame and the fishing line;
a reciprocating member movably mounted on the vertical frame member, the reciprocating member including a plurality of fin members and line engaging member for engaging a draw line, the fin members and line engaging members of the reciprocating member being movable with respect to the mounting frame such that the line engaging member is caused to reciprocate forward and backward with respect to the mounting frame generally in the direction of movement of the mounting frame as the reciprocating device is towed through the water, the reciprocation of the line engaging member imparting forward and backward movement to the draw line and fishing line as the reciprocating trolling device is towed through the water; and
the fin members are not aligned with the planar orientation of the vertical frame member and horizontal frame member.

11. The underwater reciprocating trolling device of claim 10 further including a generally cylindrical line capture device extending from the horizontal frame member to releasably engage the draw line prior to engagement of the draw line with the reciprocating member.

12. The underwater reciprocating trolling device of claim 11 further including a draw line guide extending from the horizontal frame member to align the draw line with the line capture device.

13. The underwater reciprocating trolling device of claim 12 wherein the draw line includes a bead thereon to cause the draw line to release from engagement with the line capture device.

14. The underwater reciprocating trolling device of claim 10 wherein the reciprocating member includes a wrapping cylinder, fin members and a line engagement member and movement of the fin members and line engagement member relative to the wrapping cylinder causes winding and unwinding of the draw line on the wrapping cylinder.

15. The underwater reciprocating trolling device of claim 10 wherein the draw line includes a bead thereon to cause the draw line to release from engagement with a line capture device.

16. The underwater reciprocating trolling device of claim 10 further including a keel member on the vertical frame member and wherein the keel member is adjustable to change the relative direction of travel of the reciprocal trolling device through the water.

17. The underwater reciprocating trolling device of claim 10 further including a clip member to releasably engage the draw line with the fishing line.

18. An underwater reciprocating trolling device for downrigger trolling wherein a fishing line and attached lure are releasably clipped to a weighted cable and lowered from a boat by a reel to a desired depth into the water for trolling, said reciprocating trolling device being non-floating and being adapted to be lowered to said desired depth on a cable, the reciprocating trolling device comprising:
a mounting frame attached to the cable and having a vertical frame member and horizontal frame member wherein the vertical frame member and horizontal frame member form a first generally planar orientation;
a draw line extending between the mounting frame and the fishing line;
a reciprocating member movably mounted on the vertical frame member, the reciprocating member including a plurality of fin members and line engaging member for engaging a draw line wherein the fin members and line engaging member of the reciprocating member being movable with respect to the mounting frame such that the line engaging member is caused to reciprocate forward and backward with respect to the mounting frame generally in the direction of movement of the mounting frame as the reciprocating device is towed through the water, the reciprocation of the line engaging member imparting forward and backward movement to the draw line and fishing line as the reciprocating trolling device is towed through the water;
the fin members are not aligned with the planar orientation of the vertical frame member and horizontal frame member; and
a generally cylindrical line capture device extending from the horizontal frame member to releasably engage the draw line prior to engagement of the draw line with the reciprocating member.

19. The underwater reciprocating trolling device of claim 18 including a generally cylindrical line capture device extending from the horizontal frame member to releasably engage the draw line prior to engagement of the draw line with the reciprocating member and the line capture device is aligned with the first planar orientation of the vertical frame member and horizontal frame member; and
further including a draw line guide extending from the horizontal frame member to align the draw line with the line capture device.

20. The underwater reciprocating trolling device of claim 18 wherein the line capture device includes an engagement wing thereon to receive the draw line therethrough as the line engaging member rotates.
